(19) United States
(12) Patent Application Publication
(10) Pub. No.: US 2004/0093585 A1
(43) Pub. Date: May 13, 2004

(54) Holos-a simulation and multi mathematical modelling tool

(76) Inventors: Athena Christodoulou, Bristol (GB); Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(21) Appl. No.: 10/289,594

(22) Filed: Nov. 7, 2002

(51) Int. Cl. G06F 9/44

(52) U.S. Cl. 717/104; 717/100; 717/110

(57) ABSTRACT

A method of modelling business processes and/or logical networks comprises:

expressing at least two models in a common language, wherein each of the models relates to at least part of a business process and/or a logical network in a common language;

executing the at least two models in the common language; and

abstracting the at least two models to simplify said at least two models.

### FIELD OF THE INVENTION

This invention relates to a method of modelling a logical system, particularly, but not limited to a method of modelling computer networks and/or business processes.

### DESCRIPTION OF THE PRIOR ART

It is widely known that computer systems engineers and architects rarely model their systems before construction and deployment, unlike their civil engineering counterparts. There are many reasons why they do not model but major influences include: the perception that models are never detailed enough to reflect the ‘true’ behaviour of the system; and the difficulty of learning the appropriate techniques, especially in the light of the former prevailing view.

Simulation techniques have had some success as generic modelling approaches. In the large part this is because the representation of the models is often undertaken in a standard programming language of which the engineer is already familiar. However, whilst the use of a general purpose programming language frees the engineer from learning any new syntax, it does introduce a risk of errors in their own constructed simulation framework, and often repetitious coding of essentially the same structures.

Using Simula [3-see references given at the end of the description] as his base language, during the course of constructing more than 70 modelling examples, Graham Birtwistle discovered that he was constantly writing the same structures and consequently wrote a framework (DEMOS) [2] to support those activities. This simple language has had considerable success as a presentation language for discrete event simulations. As the framework provides all of the basic synchronisation and timing mechanisms it is possible (at least via repeated use) to reduce the possibility of error in the underlying simulator.

More analytic approaches to modelling are typically not adopted as the level of expertise required usually means that any particular modeller will only be aware of a limited number of techniques. As it is often the case that the precise questions that the model needs to address have a major impact on the choice of modelling approach, the consequences of an inappropriate choice (such as delayed or no results, wasted time) mean that no abstract model is attempted.

Our view is based on the following observations about the experimental comprehension of models (or simulation). Simulation is considered a powerful modelling approach because:

1. it provides a clear debug by execution approach, reassuring the modeller that the basic system description is correct;

2. data is always obtained, little risk of no results;

3. there is no need to know in advance what questions you need to answer;

4. there is little need to abstract, if any;

5. the problem will always be representable, if we assume the language is Turing complete, i.e. equivalent in computational power to a Turing machine.

6. the dynamic presentation can be very compelling, especially as an explanatory tool for others.

However, a pure simulation approach to understanding a system is limited in many ways:

1. the results are fundamentally experimental in nature, and experiments are always hard to design and frequently ambiguous;

2. we have to execute the model on each data point, rarely do we have a reasonably small parameter space;

3. it does not make the modeller abstract and concentrate on the “essence” of their problem;

4. it is very language dependent;

5. it is exposed to programming errors both in the model and in the underlying execution environment.

It is seen as beneficial to get all of the benefits of both of the above described basic approaches to modelling.

### SUMMARY OF THE INVENTION

According to a first aspect of the invention, a method of modelling business processes and/or logical networks comprises:

expressing at least two models in a common language, wherein each model relates to at least part of a business process and/or a logical network;

executing the at least two models in the common language; and

abstracting the at least two models to simplify said at least two models.

The method preferably includes providing questions to at least one of the models, preferably with a view to simplifying at least one of the models, based on an answer/answers received from the model.

The models may include variable parameters that are common between at least two models.

The questions may be provided to assess the impact of a variation in behaviour of at least one of the models on another of the models.

The questions may be used to assess the effect of deleting or refining a section of at least one model.

A question may be in the form of one or more variables for input into at least one of the models.

The at least two models may represent different aspects of the business process/logical network being modelled. The aspects may at least partially overlap, or have at least one variable parameter in common.

A first of the at least two models may represent a first modelling domain. A second of the at least two models may represent a second modelling domain. The method may include translation of results and/or requirements of the at least two models between the first and second modelling domains.

The common language expression of one of the models may be translated/compiled into a mathematical notation that is preferably suited to the model concerned or suited to a question to be asked of the model concerned. The mathematical notation may be Petri nets, differential equations, process algebra or other analysable notational forms.

The translation between modelling domains and/or representations of the models beneficially allows different aspects of the models to be considered, to thereby assist in simplification of the models.

The method preferably allows real time running of a business process model and/or logical network simulation, preferably due to simplification of the models that is achieved by the method.

Preferably, more than two models are described in the common language. The models may be two or more of a business model, a user model, a system architecture model, an operations model and a finance model.

The invention extends to a computer programmed to perform the method of the first aspect.

The invention extends to a recordable medium bearing a computer program operable to perform the method of the first aspect.

According to another aspect of the invention, a method of modelling business processes and/or logical networks comprises:

expressing at least two models of at least part of a business process and/or a logical network in DEMOS2K;

executing the at least two models in DEMOS2K; and

abstracting the at least two models to simplify said at least two models, wherein the method includes providing questions to at least one of the models with a view to simplifying at least one of the models.

All of the features described herein may be combined with any of the above aspects, in any combination.

To achieve some of the goals, particularly the proper definition of our presentation language we need it to be closed i.e., the language is self-contained. The original DEMOS system was dependent in a large part on the underlying Simula and thus to formalise the complete language would require a formalisation for all of Simula, a very difficult task. So given our earlier work on the semantics of DEMOS both operational [5, 6] and denotational [7, 22, 8, 9] we took this language and extended it until we could express (hopefully elegantly) all of the original examples given in πDEMOS, a System for Discrete Event Modelling in Simula (see [2] above). Equally we attempted to achieve the same level of expressive power as Milner's Pi calculus.

For a better understanding of the invention and to show how the same may be brought into effect, specific embodiments will now be described by way of example and with reference to the accompanying drawings in which:

### BRIEF DESCRIPTION OF THE DRAWINGS

FIG. 1 is a schematic view of the modelling of problems in DEMOS2K;

FIG. 2 is a view of a user interface for the modelling system;

FIG. 3 is a schematic view of results of the method described herein;

FIG. 4 is a schematic view of a simple translation example as a Petri net;

FIG. 5 is a schematic flow diagram showing the use of modelling system described herein; and

FIG. 6 is a schematic flow diagram of the integration of the modelling system with other modelling elements.

### DESCRIPTION OF THE PREFERRED EMBODIMENTS

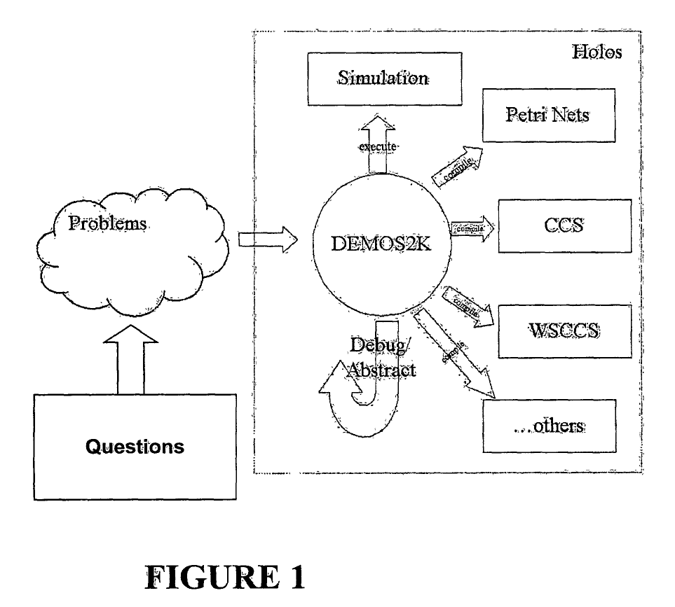

The HOLOS simulation and multi-mathematical modelling tool consists of a process oriented concurrent system presentation language which may be executed (simulated) along with a set of compilers into multiple formal modelling techniques. This view is given in FIG. 1, in which problems are described by models set in DEMOS2K, the latter being executed to simulate the problem. The DEMOS2K is then abstracted and debugged to provide a more robust representation of the problem(s).

The current implementation permits the addition of arbitrary extra compilers as sml [16] functions, immediate from the language details, see [28] for further details.

DEMOS is a process oriented discrete event simulation language originally defined as an extension to the Simula language. The current version has little changed from the original other than in how entities slave themselves to others. DEMOS has essentially 3 components.

1. entities, defined as instances of classes. A class provides the definition of a collection of actions that an instance entity will undertake. An entity can be thought of as an individual parallel process interacting with others and the environment;

2. resources, are atomic accessible counters and are used as locks (limits) similar to semaphores [29];

3. bins, are atomic counters of numbers of objects in a queue. Bins form desynchronisation points, i.e. they don't require simultaneous access, as opposed to resources that are synchronisation points.

These elements all have definitional forms:

1. entity(name,className,offset) and class name=body

2. res(foo,amt);

3. bin(foo,amt).

Entities are the active elements of the system, resources can be thought of as semaphores and bins are points of asynchrony. Entities interact with other elements of the system in the following manner:

1. getR(resN,amt) and putR(resN,amt) respectively claim and free the amt of resource resN, an entity cannot return amounts of resource it does not own;

2. getB(binN,amt) and putB(binN,amt) respectively claim and free the amt of bin binN;

3. sync(name) slaves the current entity on name. The current entity waits to be claimed and released on the name and then continues its execution from the next command;

4. getS(syn,amt) and putS(syn,amt) respectively claim and free the amt of sync syn, an entity cannot return amounts of sync it does not own.

5. Entity(name,className,offset) spawns a new instance of className called name at time offset into the future;

6. Hold(ti) advances the simulation clock ti into the future.

Collectively, getR(resN,amt), getB(binN,amt), getS(syn,amt) are referred to as acquisitions. The following compound operations are defined on them:

1. req[acq1, . . . , acqN] requires that all of the requests can be granted simultaneously before the entity can proceed.

2. try [req1 ]then Bd1 etry [req2]then Bd2 . . . etry [reqN] then {BdN}; will try each of the requests in turn until one can be satisfied, otherwise it blocks until one can be satisfied. Often used with . . . etry [ ] then hold(t) as a non-blocking test.

Finally we allow loops:

1. repeat body executes body forever;

2. do n body executes body n times;

3. while [req] body as long as the requirement can be met execute the body. Note a requirement can be a Boolean expression.

A DEMOS program consists of an entity (conventionally referred to as main) that sets up class and other definitions and then invokes entities to form the running system.

Operational Semantics

The execution of a DEMOS program is defined operationally, the first analysis of the interaction fragments are described in references [5, 6]. The full semantics runs to some 50 pages (25). We have to define how the system state will change as a function of all of the commands we may execute. The system state consists of 3 parts:

1. event list, those entities which are ‘active’;

2. blocked list, those entities waiting on acquisitions;

3. a store, holding variable/constant values, class definitions, resource, bin and sync levels;

The store can be defined in many different ways. One example would be association lists or hash tables. Both the event list and the blocked list consist of process descriptors so we give an outline of their definition. Finally in this section we present the outline of the semantics with the full presentation of the semantics of putBS.

Event Notices

The event notice has the following form, PD(id,pr,Body,Attrs,evt), which can be understood as follows:

1. id a name identifying the entity;

2. pr the current priority of this entity, can be changed with the priority command;

3. Body the list of actions the entity wishes to engage in, the list providing the order over the actions;

4. Attrs a store containing three types res, sync and var. The res being the name and amount of currently held resources. The sync a list of synced processes in the order in which they were claimed. The var is the values of local variables.

5. evt the time at which this notice should next be considered active.

Operational definitions

As each program command is executed the system will change from one state to another

(εL, BL, S) [symbol] (εL′, BL′, S′)

Execution is so framed that the next action to be executed is always the first action in the action list of the first object in the event list. Thus given the event list pattern-matching

(εL=PD (c, pr, b::Body, Attrs, evt):: . . .

the next action must be b and the system time is said to be at the time of this action, evt.

It is now straightforward to give a semantics as a case statement over the structure of, DEMOS commands, as sketched below:

1. an error arises if the event list becomes empty (the system should be shut down with a call on close).

exec ([ ], BL, S)=error

2. When a process has exhausted its actions, a check is made to see whether it still owns any attributes. An error results if it does. If not, all is well. The object is deleted from the event list. The simulation proceeds from the next action of the new current.

exec (PD(c,pr,[ ], Attrs, evt)::εL, BL, S)

=if Attrs=empty

then exec(EL, BL, S)

else error

3. The normal case—we focus on PD(c, pr, b::Body, Attrs, evt) the object at the head of the event list, and execute its next action b. The names Body, Attrs, and evt are directly accessible in the case clause, as is cp′, the “expected next current process object”. We add some global information such as current simulation time along with bin and resource levels, into the store at this point.

putBS(id,exL,reL,sL)

Add a bin item with parameters given in the expression list exL to the bin id, also has resources as specified by reL and syncs specified by sL;

Semantics:

putBS(id,exL,reL,sL)

=(evalN(Attrs αS)id, bins)∉S [symbol] error

□let n=evalN(Attrs αS)id in

let vL=map evalN(AttrsαS)exL in

let rL=map evalR(AttrsαS)reL in

let sL=map evalN(AttrsαS)sL in

if pr=−15000 then

let S′=ADDITEM(n,bins,(vL,rL,syN))S in

promote (putBS(n,eL,reL,sL),evt, εL, BL, S′)

else

let (cp″,syN)=removeSL(sL,cp′[ ]) in

in(ENTER PD(cn,−15000, [putBS(n,vL,rL,syN)], ( ),evt)removeRL(rl,cp″)::εL,

BL, S)

Interpretation:

1. (evalN(AttrsαS)id, bins)∉S: error if the bin identifier does not exist:

2. Normal case

(a) let n=evalN(AttrsαS)id: work out the resource name;

(b) let vL=map evalN(AttrsαS)exL: evaluate the expressions passed with the bin item;

(c) let rL=map evalR(AttrsαS)reL: evaluate the amounts of each resource passed along with the bin item;

(d) let sL=map evalN(AttrsαS)sL: and work out the ground sync names;

(e) if pr=−15000 then: we are actually doing the put;

(f) let S′=ADDITEM(n,bins, (vL,rL,syN))Sput the parameterised bin item in the store, with its associated values, resources and syncs;

(g) use the semantic function promote(putBS(n,eL,reL,SL),evt,εL, BL, S′) to enable any entities that may have become unblocked. Since the evaluated form has been stored in the state, we only use the name and hence have no state overwrite problems. Note the current entity has only one action and hence will die.

(h) else

(i) let(cp″,syN)=removeSL(sL,cp′,[ ]): remove the syncs from the current process notice, note may lead to an error if we pass on syncs we do not have;

(j) (ENTER PD(cn,−15000,[putBS(n,vL,rL,syN)],( ) evt) remove RL(rl,cp″)::εL, BL, S): then enqueue the actual return as the last activity at this clock instant.

Execution Support

For any model simulation exploration by execution provides us with two major benefits. Firstly it allows us to explore our model dynamically and often identify errors in our modelling. Secondly, there are limits to the scale of models that can be addressed analytically and consequently a simulator guarantees that the modelling effort will deliver some results, even if their provenance is limited.

The DEMOS simulator is component based:

1. an engine written in sml [28], to give closest match to the operational semantics;

2. sml parser;

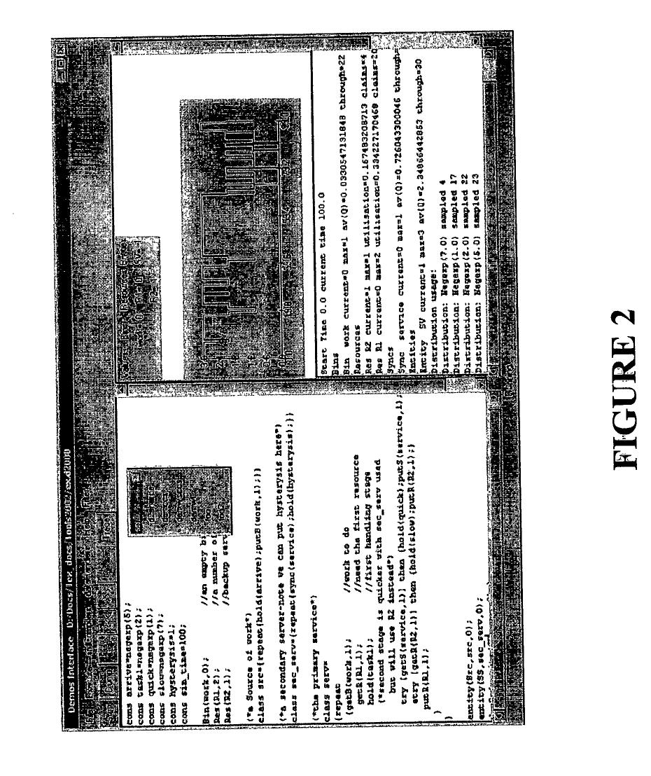

3. a perl [27]/Tk front end, displayed in FIG. 2;

4. a perl/Tk data accumulator, intercepts output data and represents it in a graphical form;

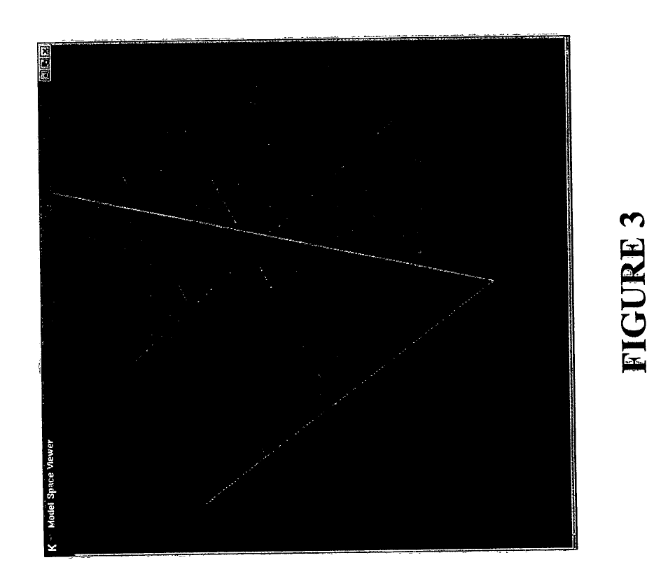

5. a VRML [1] data visualisation system, displayed in FIG. 3 showing throughput against various systems parameters.

One of the major drivers in the above choices was that all of the components should be based on open software. We have also concentrated our compilation efforts into those areas where tool support is also open.

Furthermore the front end supports plug in compilers. It can be extended with sml components that can be executed on the currently live DEMOS program. These additions can be made without any coding within the primary interface. Other plugins allow the addition of different data filters written in perl, the ability to add perl components to the main interface, and the ability to activate executables and batch files.

Translations

To formally present each of the following translations will require approximately 20 pages each so in the interest of brevity we will take the example DEMOS program below and show its translation into each of the four formal presentations.

Our simple example works as follows: work is generated by a source at a rate arrive, this work accumulates in a bin called em work. A server takes an item of work and then processes it using resource R1, this takes an amount of time task1. This resource is needed for all processing. It then has a choice for the second stage of processing. If there is a sec_serv slave available it is used and returned and this stage of the job takes a quick amount of time. This path is preferred. Alternatively it can make use of resource R2 and the secondary task will take time slow. Having completed the task whichever set of resources/syncs are held are returned, and the complete job begins again.

| Bin(work,0); | //an empty bin |
|---|---|
| Res(R1,2); | //a number of slots |
| Res(R2,1); | //backup server |
| (*a Source of work*) | |
| class src={repeat{hold(arrive);putB(work,1);}} | |
| (*a secondary server-note we can put hysterysis here*) | |
| class sec_serv={repeat{sync(service);hold(hysterysis);}} | |
| (*the primary service*) | |
| class serv= | |
| {repeat | |
| {getB(work,1); | //work to do |
| getR(R1,1); | //need the first resource |
| hold(task1); | //first handling stage |

```
  (*second stage is quicker with sec_serv used
    but will use R2 instead*)
  try [getS(service,1)] then {hold(quick);putS(service,1);}
  etry [getR(R2,1)] then {hold(slow);putR(R2,1);}
  putR(R1,1);
  }
}
entity(Src,src,0);
entity(SS,sec_serv,0);
do 3 {entity(service,serv,0);}
hold(sim_time);
close;
```

Petri Nets

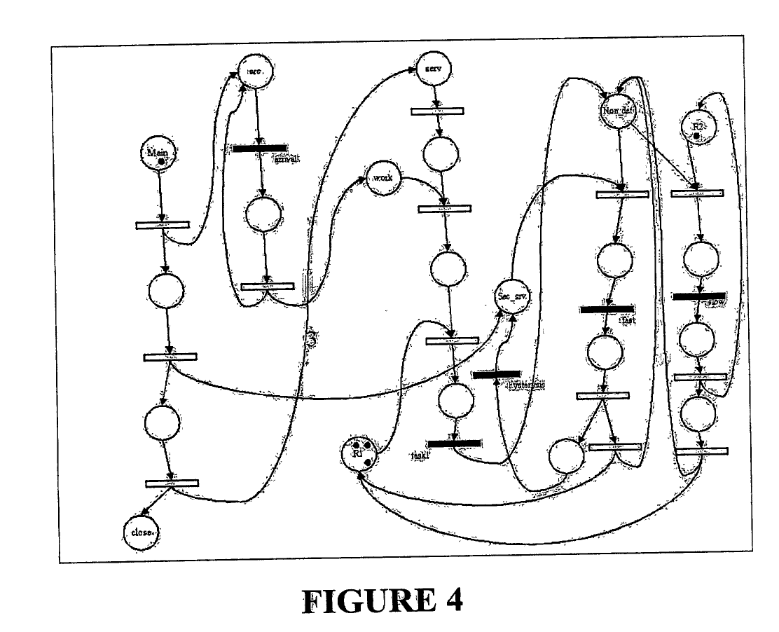

The translation of the above DEMOS program into a probabilistic Petri net [17, 18, 19) is presented in FIG. 4, for an interpretation of Petri Nets see [17, 18, 19]. An account of the full translation of DEMOS currently understood can be found in reference [26]. These models can be automatically analysed with tools such as those described in [20].

CCS (Calculus of Communicating Systems)

The original work on the relationship between DEMOS and CCS [12] was in the form of structural observation [5]. An automatable translation is presented in [22, 8, 9] and its relationship with the operational semantics demonstrated in [7]. The CCS representation allows us to address questions such as livelock and deadlock [see 12], using tools including the Edinburgh Concurrency Workbench [15, 10].

*Bin work max=3
agent Bwork_3 getwork.Bwork_2;
agent Bwork_2 getwork.Bwork_1 + putwork.Bwork_3;
agent Bwork_1 getwork.Bwork_0 + putwork.Bwork_2;
agent Bwork_0 putwork.Bwork_1;
*Resource R1
agent R1_2 getR1.R1_1;
agent R1_1 getR1.R1_0 + putR1.R1_2;
agent R1_0 putR1.R1_1;
*Resource R2
agent R2_1 getR2.R2_0;
agent R2_0 putR2.R2_1;
*class src
agent Csrc ‘putwork.holdArrival.Csrc;
*class sec_serv
agent Csec_serv getSservice.putSservice.holdHysterysis.Csec_serv;
*class serv
agent Cserv ‘getwork. ’getR1.holdtask1.CservCh;
agent CservCh ‘getSservice.holdfast. ’putSservice. ‘putR1.Cserv +
’getR2.holdslow. ‘putR2. ’putR1.Cserv;
set R{getwork,putwork,getR1,putR1,getR2,putR2,getSservice,
putSservice};
agent Main (Bwork_0|R1_2|R2_1|Csrc|sec_serv|Cserv|Cserv|Cserv) /R;

(1)WSCCS (Waited Synchronous CCS)

To formally analyse the probabilistic, priority and timing properties of DEMOS programs we need a formal language that can encompass all of these phenomena. A prototypical extension to Milner's sccS [11] is WSCCS. This translation can be extended to a large fragment of DEMOS [25] and there is detail of automated analysis support in the same document.

*Bin work max=3
bs Bwork_3 1.getwork:Bwork_2 + 1.t:Bwork_3
bs Bwork_2 1.getwork:Bwork_1 + putwork.Bwork_3 + 1.t:Bwork_2
bs Bwork_1 1.getwork:Bwork_0 + putwork.Bwork_2 + 1.t:Bwork_1
bs Bwork_0 1.putwork:Bwork_1 + 1.t:Bwork_0
*Resource R1
bs R1_2 1.getR1:R1_1 + 1.t:R1_2
bs R1_1 1.getR1:R1_0 + 1.putR1:R1_2 + 1.t:R1_1
bs R1_0 1.putR1:R1_1 + 1.t:R1_0
Resource R2
bs R2_1 1.getR2:R2_0 + 1.t:R2_1
bs R2_0 1.putR2:R2_1 + 1.t:R2_0
*class src
bs Csrc 1@1.putwork\hat{ }-1:Csrc1 + 1.t:Csrc
bs Csrc1 Arrival.t:Csrc + (1-Arrival).t:Csrc1
*class sec_serv
bs Csec_serv 1.getSservice.Csec_serv_1 + 1.t:Csec_serv
bs Csec_serv_1 1.putSservice:Csec_serv_2 + 1.t:Csec_serv_1
bs Csec_serv_2 Hysterysis.t:Csec_serv + (1-Hysterysis) .t:Csec_serv_2
*class serv
bs Cserv 1@1.getwork\hat{ }-1:Cserv_1 + 1.t:Cserv
bs Cserv_1 1@1.yetR1\hat{ }-1:Cserv_2 + 1.t:Cserv_1
bs Cserv_2 task1.t:CservCh + (1-task1).t:Cserv_2
bs CservCh 1@2.getSservice\hat{ }-1:CservCh_1_1 + 1@1.getR2\hat{ }-1:CservCh_2_1 +
1.t:CservCh
bs CservCh_1_1 fast.t:CservCh_1_2 + (1-fast) .t:CservCh_1_1
bs CservCh_1_2 1@1.putSservice:Cserv_3 + 1.t:CservCh_1_2
bs CservCh_2_1 slow.t:CservCh_2_2 + (1-slow) .t:CservCh_2_1
bs CservCh_2_2 1@1.putR2\hat{ }-1.Cserv_3 + 1.t:CservCh_2_2
bs Cserv_3 1@1.putR1\hat{ }-1#done:Cserv + 1.t:Cserv_3
basi R done
btr Main Bwork_0|R1_2|R2_1|Csrc|sec_serv|Cserv|Cserv|Cserv\R;

WSCCS(2)

A dual approach to the representation of performance problems within a synchronous process algebra allows us to greatly reduce the size of the state space [23] and consequently the analysis time can also be exploited to analyse DEMOS programs. An example of that form of translation is presented below.

*Bin work max=3
bs Bwork_3 1.getwork:Bwork_2 + 1.tz:Bwork_3
bs Bwork_2 1.getwork:Bwork_1 + putwork.Bwork_3 + 1.t:Bwork_2
bs Bwork_1 1.getwork:Bwork_0 + putwork.Bwork_2 + 1.t:Bwork_1
bs Bwork_0 1.putwork:Bwork_1 + 1.t:Bwork_0
*Resource R1
bs R1_2 1.getR1:R1_1 + 1.t:R1_2
bs R1_1 1.getR1:R1_0 + 1.putR1:R1_2 + 1.t:R1_1
bs R1_0 1.putR1:R1_1 + 1.t:R1_0
*Resource R2
bs R2_1 1.getR2:R2_0 + 1.getR2#putR2.R2_1 + 1.t:R2_1
bs R2_0 1.putR2:R2_1 + 1.t:R2_0
*class src
bs Csrc 1@1.putwork\hat{ }1#dArrival:Csrc + 1.t:CSrc
*class sec_serv
bs Csec_serv1.getSservice.Csec_serv_1+ 1.getSservice#putSservice:Csec_serv_2 +
1.t:Csec_serv
bs Csec_serv_1 1.putSservice:Csec_serv_2 + 1.t:Csec_serv_1
bs Csec_serv_2 1.dHysterysis:Csec_serv
*class serv
bs Cserv 1@1.getwork\hat{ }-1#getRV\hat{ }-1#tdtask1:CservCh + 1.t:Cserv
bs Cserv Ch 1@2.getSservice\hat{ }-1#dfast#putSservice\hat{ }-1#putR1\hat{ }-1#done:Cserv \ +
1@1.getR2\hat{ }-1#dslow#putR2\hat{ }-1#putR1\hat{ }-1#done:Cserv + 1.t:CservCh
basi R done, dArrival, dtask1, dfast, dslow
btr Main Bwork_0|R1_2|R2_1|Csrc|sec_serv|Cserv|Cserv|Cserv\R;

Abstraction

Abstraction is an activity largely undertaken by modellers. In most modelling contexts the problem owner will not be responsible for constructing the model. They engage in a discourse with a modeller who, usually, abstracts the system under consideration and then derives what they believe the information the problem presenter required. One of the consequences of this is that often the amount of abstraction used gives the problem owner little or no belief in the results of the model. As organisations grow and the gap between problem owner and modeller grow increase the problem can become acute.

One of the consequences of the hegemony of the C programming language has been the work on optimising compilers onto particular processors. In this context there are both globally useful work-optimisations that work on all underlying architectures—and locally useful work-optimisations that work on particular underlying architectures. In the context of modelling we may regard a particular mathematical analysis as a processor and the act of translating from some neutral representation into that as being compilation. In this context if the neutral representation can be comprehended by execution then we have the chance to explain our abstraction. We can proceed by presenting a chain of models aimed at a particular analysis technique. In the worst instance we can demonstrate by experiment that the models are broadly in agreement. In the best case we may be able to prove that particular rewrites cannot change the results of the model.

However, for the above to work we must agree to concentrate on a particular presentation language, which is something that has been singularly lacking within the formal methods community. The major problems in this space will be the temptation to use a language that is particularly suited to one mathematical technique and the obvious consequences of the triviality of achieving Turing completeness with almost any programmatic presentation.

### CONCLUSIONS

There are clear and immediate benefits to being able to take one representation of a model and derive formal models that permit multiple forms of an analysis. However the attempt to produce such systems present us with major challenges. Firstly the definition of the primary presentation language must extend beyond that of its syntax. Any choice of initial presentation language will have an intended execution model and unless this is well defined it will be impossible to comment on the relationship of any results derived from a more formal analysis of a compilation of the original text. One pleasing result is that the outcome in our examples above of the DEMOS2K text being much shorter than the other forms is the usual outcome.

The above observation limits our choice of original presentation given the difficulty of defining the behaviour of even relatively “clean” languages [13]. Our choice of presentation language has been guided by two principles; firstly, it has been widely used in the past; secondly, we already knew that it could be formally defined and compiled into analysable mathematics which could be related to the original definition. The current form of DEMOS is largely a consequence of having to remove all dependencies on an underlying Simula system. Otherwise we would need to provide a semantics for that language, an even greater challenge. Equally we wished to remove all explicit scheduling activities from the coder and to achieve (as much as possible) expressive power comparable with Milner's Pi calculus [14].

Our interface design is deliberately intended to permit the easy addition of alternative compilers to encourage experimentation within as many forms as possible.

One major area of interest is the translation of one DEMOS program into another. The major benefit of process algebraic representations is that we can (occasionally) prove that various alternative forms of model are equivalent. Often merely changing the view of the model can lead to better forms of compilation. In particular the two forms (Petri net/automata) views shown in this document provide an interesting view of DEMOS2K. The Petri view is based essentially translating all interactions as mediated by bins. The automata (Process Algebra) view would be of all interactions being syncs. Both of these views provide normal forms for DEMOS which may admit efficient compilation.

Finally there is abstraction in the traditional sense, of omitting some of the complexity of the problem. One of our major requirements was the ability to construct ‘chains’ of models as witnesses to abstraction, and indeed this is relatively straightforward within the syntax of DEMOS. Clearly an ideal situation to reach would be one where this abstraction is (largely) automated in response to the particular questions the modeller has. Equally clearly this is an immense technical challenge, but possibly achievable when viewed from the perspective of compiler optimisation.

An example of an abstraction of a simulation model is given below, in DEMOS2K syntax. As can be seen the model was abstracted between Version 1 and the final version. This was done manually by a skilled worker. The model describes a prototypical web-based photograph sharing system. The abstraction is achieved by spotting redundancy, amending representations to more efficient forms and based on algebraic transform rules.

Version 1

(*This version has threaded web-servers...
Started 28-9-2000*)

| | |
|---|---|
| Cons Web_servers=5; | (*number of web servers*) |
| Cons Image_servers=1; | (*Image servers*) |
| Cons thread_limit=20; | (*number of connections per web |
| | server*) |
| Cons image_size = 0.5; | (*average image size in mega- |
| | bytes*) |
| Cons outbound_rate = 12.5; | (*megaBYTES/second on outgoing |
| | links*) |
| Cons max_image_page = 12; | (*number of images per page*) |
| Cons Images=Puni(1, | (*Distribution of image number*) |
| max_image_page); | |
| Cons arr_int = 0.35; | (*arrivals intervals in seconds, |
| | including reappers*) |
| Cons internal_transfer = 12.5; | (speed of internal network*) |
| Cons wrapper_size = 0.001; | (*number of bytes on pages |
| | wrapping images*) |

(*-----------------------------------------------------------------*)
Var DEMOS_TIME = 0.0; Var reqs_served = 0; Var total_time=0;
Var i=0;
(*index for
(*-----------------------------------------------------------------*)

| | |
|---|---|
| Res(Network, 1); | (*Internal network links*) |

```
Res(Image_server, Image_servers);
i:=0
(*set up the processor and thread limit for each web server*)
Do Web_servers
  {Res(Proc[i], 1);
  Res(threads[i],thread_limit);
    i:=i+1}
(*the classes for generating data and time in system*)
Class Report =
{while []
  {hold(10);
  try[reqs_served>0]
  then {Trace(“Service_time=%v”, total_time/reqs_served);
```

Trace(“Reqs handled=%v”,reqs_served);
Trace(“Time taken=%v”,total_time);
}

}
}
Class Customer =
{Local var start=DEMOS_TIME;
Entity(Customer,nege(arr_int));

| | |
|---|---|
| Sync(web); | (*get a page*) |

total_time:=total_time+(DEMOS_TIME-start);
reqs_served:=reqs_served+1;
}
(*----------------------------------------------------------*)

| | |
|---|---|
| Var j=0; | (*remove when call by val |
| | included*) |
| Class Web_Server(i)= | |
| {local var my_proc=i; | |
| priority (5-6); | (*hack to cope with old parser*) |
| while [] | |

{req[getS(web,1),getR(threads[my_proc],1)]; (*inside thread limit*)

| | |
|---|---|
| j:=my_proc; | (*more hack*) |

Entity(“Thread”,Web_Thread(j),0,[(threads[my_proc],1)],[web]);

(*spawn a handler*)
(*Give it the thread resource
and the sync*)

}}
Class Web_Thread(i) =
{local var my_proc=i;

| | |
|---|---|
| getR(Proc[my_proc],1); | (*need a processor*) |
| Hold(wrapper_size/ | (*transfer wrapper*) |
| outbound_rate); | |

```
  putR(Proc[my_proc],1);
  Do Images
  {req[getR(Proc[my_proc],1),getR(Network,1),getR(Image_server,1)];
```

(*get from server*)

```
  Hold(image_size/internal_transfer);
  putR(Network,1);putR(Image_server,1);
  Hold(image_size/outbound_rate); (*over the web)
  putR(Proc[my_proc],1);
}
putR(threads[my_proc],1);
putS(web,1);
}
i=0;
Do Web_servers
  {Entity(“Web_Server”,Web_Server(i),0);
    i:=i+1;
  }
Entity(Customer,0);
(*Entity(Report,0);*)
Hold(1000);
Trace(“DUMP”);
Trace(“Service_time=%v”,total_time/reqs_served);
Trace(“Reqs_handled=%v”,reqs_served);
Trace(“Time_taken=%v”,total_time);
TRACE(“Internal_rate=%v”,internal_transfer);
TRACE(“External_rate=%v”,outbound_rate);
Trace(“Web_Servers=%v”,Web_servers);
Trace(“Threads=%v”,thread_limit);
Trace(“Arrival_rate=%v”,arr_int);
Trace(“Image_size=%v”,image_size);
Trace(“Image_max=%v”,max_image_page);
Close;
```

Class Customer=
{Local var start=DEMOS_TIME;
Entity(Customer,nege(arr_int));

| | |
|---|---|
| Sync(web); | (*get a page*) |

```
  total_time:=total_time+(DEMOS_TIME-start);
  reqs_served:=reqs_served+1;
}
Class Customer=
{while []
  {putB(web_req,1);
  Hold(nege(arr_int));
  }
}
Class Web_Server(i)=
(local var my_proc=i;
```

| | |
|---|---|
| priority (5-6); | (*hack to cope with old parser*) |
| while [] | |

{req[getB(web_req,1),getB(threads[my_proc],1)]; (*inside thread

| | |
|---|---|
| | limit*) |
| j:=my_proc; | (*more hack*) |
| Entity(“Thread”,Web_Thread(j),0); | (*spawn a handler) |
| } | |
| } | |
| Class Web_Thread(i)= | |
| {local var my_proc=i; | |
| local var start=DEMOS_TIME; | |
| getR(Proc[my_proc],1); | (*need a processor*) |
| Hold(wrapper_size/ | (*transfer wrapper*) |
| outbound_rate); | |
| putR(Proc[my_proc],1); | |
| Do Images | |

{ req[getR(Proc[my_proc],1),getR(Network,1),getR(Image_server,1)];

| | |
|---|---|
| | (*get from server*) |
| Hold(image_size/internal_transfer); | |
| putR(Network,1);putR | |
| (Image_server,1); | |
| Hold(image_size/outbound rate); | (*over the web*) |
| putR(Proc[my_proc],1); | |
| } | |
| total_time:=total_time+ | |
| (DEMOS_TIME-start); | |
| reqs_served:=reqs_served+1; | |
| putB(threads[my_proc],1); | |
| } | |
| Class Web_Server= | |
| {local var start_time=0; | |
| while [] | |
| {getB(page_req,1); | (*someone wants me*) |
| start_time:=DEMOS_TIME; | |
| Hold(wrapper_size/ | (*transfer wrapper*) |
| outbound_rate); | |
| Do Images | |

```
{ req[getR(Network,1),getR(Image_server,1)]; (*get from server*)
  Hold(image_size/internal_transfer);
  putR(Network,1);putR(Image_server,1);
```

| | |
|---|---|
| Hold(image_size/outbound_rate); | (*over the web*) |
| } | |
| total_time:=total_time+ | |
| (DEMOS_TIME-start_time); | |
| reqs_served:=reqs_served+1; | |
| } | |
| } | |

Do Images
{ req[getR(Network,1),getR(Image_server,1)];

(*get from server*)

```
  Hold(image_size/internal_transfer);
  putR(Network,1);putR(Image_server,1);
  Hold(image_size/outbound_rate); (*over the web*)
  }
```

```
Do Images
  { req[getR(Network,1),getR(Image_server,1)]; (*get from server*)
  Hold(image_size/internal_transfer);
  putR(Network,1);putR(Image_server,1);
```

| | |
|---|---|
| Hold(image_size/outbound_rate); | (*over the web*) |
| } | |

```
Sync(Image);
  total_time:=total_time+(DEMOS_TIME-start_time);
  reqs_served:=reqs_served+1;
  }
  }
  Class Image_server=
  {while []
    {getS(Image,1);
    Hold(Images*image_size/internal_transfer);
    putS(Image,1);
    }
  }
```

| Class Customer= | |
|---|---|
| {while [] | |
| {putB(page_req,1); | |
| hold(nege(arr_int)); | |
| } | |
| } | |
| Class Web_Server= | |
| {local var start_time=0; | |
| while [] | |
| {getB(page_req,1); | (*someone wants me*) |
| start_time:=DEMOS_TIME; | |

```
  Hold(wrapper_size/outbound_rate + Images*image_size/
  outbound_rate);
```

(*transfer everything*)

```
  Sync(Image);
  total_time:=total_time+(DEMOS_TIME-start_time);
  reqs_served:=reqs_served+1;
  }
}
Class Image_server=
{while []
  {getS(Image,1);
  Hold(Images*image_size/internal_transfer);
  putS(Image,1);
  }
  }
```

It is clear that the final version is considerably less involved than the first version, showing that the abstraction process had the benefit of great simplification of the initial model.

The description above provides compilers from a common executable language, DEMOS2K, into various mathematical forms and also translations and abstractions within the DEMOS2K language.

With the description above models of, for example, business and computing systems can be framed in a mathematical form suitable to that particular method (for example an investment model is best suited to differential equations). The models can then be converted or translated into DEMOS2K. Thus, the models are all framed in the same language and using the Holos platform described herein and further described below the business, financial and systems architecture planning and design can be tied together and run as whole in order to gain information on day to day running of the system and also during planning stages to predict how the system will run.

Holos is capable of translating the results/requirements from one modelling domain into another, and does so in such a way as to make it possible not only to run the models continuously against live data, but also to translate results backwards and forwards between domains. This allows a business manager, who is a user in this example, to observe the impact of changing service level agreements, for example on the operations and systems parts of a solution. Alternatively, the user may be an operations manager, who will be able to observe the business cost of making changes to some aspect of the operations.

The benefit of DEMOS2K is that it can be re-written/compiled into many other representations, suitable for both simulation and analytic testing. Those representations include Petri nets, differential equations, process algebra.

As a business program progresses through specification to implementation, changes in the specification (which are inevitable in most businesses) are continuously entered in the most appropriate representation of the overall model. This may be in the user model, the business model, the architecture model, the operation model, the finance model, or another model. Then, implications of the changes for the rest of the system can be observed, because all models are combined in the Holos system. This gives early warning of potential conflicts of specifications, where a user service level agreement may fail under load. When the system is ultimately running, modifications, such as different features, or hardware extensions, can be checked in the same way, but in addition, real data in the form of user behaviour and system load can be used to perturb the model to predict the impact of long term trends on the behaviour of the system.

The flexibility of the system whereby a scenario can be modelled in a way appropriate to the particular domain (such as investment, maintenance or load) and also appropriate to the questions that need to be asked (such as how much investment will be needed) is particularly advantageous.

A practical implementation of the Holos system is as follows.

In order to judge the effectiveness and likely success of a supermarket home delivery system a number of models were obtained. Such models would be available from prior art analyses, but would not previously have been combined in the way to be described below. The models used were: a finance model, to obtain a view on how much would be needed to fund the home delivery service; a model of investors, to establish what type of growth may be expected from the service; a model of the users to model various scenarios based on geographical spread and amount of use required by users; a first delivery model to model time taken between a warehouse for delivery vans or between different delivery addresses; and a second delivery model to establish how quickly goods may be shipped into a warehouse.

Models of the type set out above typically have many parameters making them particularly complex. The purpose of the Holos system is to understand the gross behaviour of a project such as the home delivery service, rather than fine detail. Given that gross behaviour is of primary concern it is likely that many of the parameters are not needed to obtain a view of the trends based on different patterns of usage investment and finance for the home delivery service.

The various models are set out in DEMOS2K, which is executable. Where necessary it may be translated into a particular mathematical form which is particularly relevant to that element of a model, such as a Petri Net, differential equations or process algebra.

In addition to any standard abstracting of the model representations that may be undertaken the DEMOS2K representation of the models is subjected to the posing of questions in order to establish which parts of the model representation are necessary to determining gross behaviour. The posing of questions to the model representations is not to be confused with standard abstracting techniques, whereby manual inspection is used.

The use of questions posed to the model representations is used to establish which parts of the model representations are extraneous in determining gross behaviour.

Questions such as how many vans are required for a given level of service, the effect of warehouse location and number of warehouses may be used. Still further, questions as to varying levels of finance can be posed of the problems to ascertain which parts of the model representations are used.

By framing the questions and posing the questions significant advantages are achieved because the models can be much simplified. The simplification of the models allows real time running of the models in a much more efficient manner, because considerably fewer parameters are needed in a simplified arrangement that predicts gross behaviour than are required for an unsimplified model which will have many more parameters. The real time running of an assembly of models such as described above allows exploration of different user service level agreements and also allows explanation of how a delivery system such as this may fail under a particular load.

In a home delivery service the additional investment that is required is based on the additional staff together with IT requirements and also delivery vans. Questions relating to the level of these additional investments and the effect it has on the profitability or functionality of a system based on various loads and distributions of services and the like can be established by the questioning procedure described above. The questioning is applied to each of the various models that have been used to define the problem. This allows different questioning to be used to assess impact between different models representing the problem and their inter-relationship. Example questions are: Does the system deadlock? How many users queue at the till on average? How often do I see a time out? These questions are categorised as structural, performance and tuning types of question.

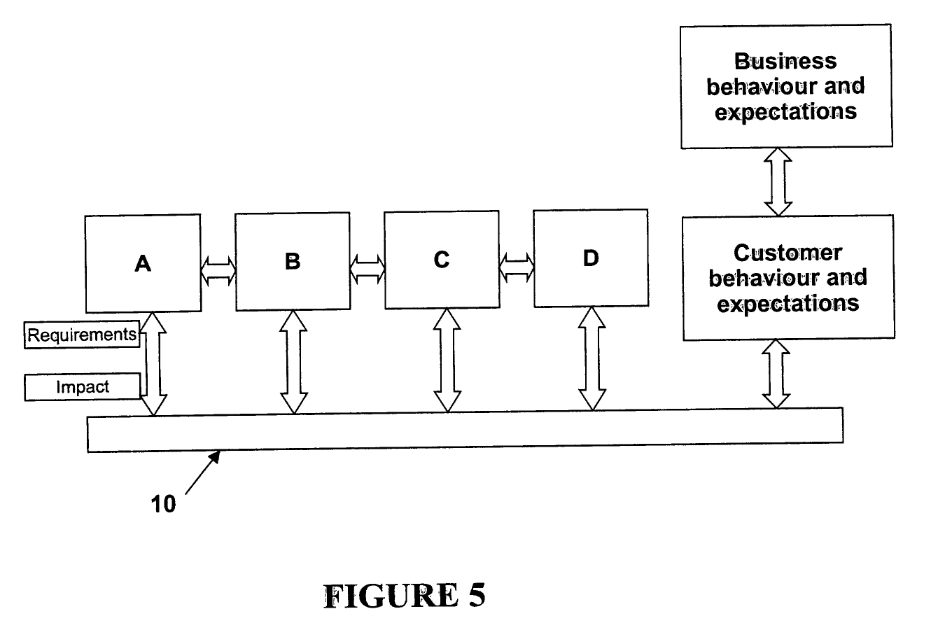

The cross domain modelling and analysis described in relation to the Holos system allows the structure shown in FIG. 5 to be achieved. In FIG. 5, the Holos system run on a computer 10 makes use of hardware (A), platform (B), applications (C) and system infrastructure (D) models. The hardware model, A, allows such variables as seek time, computer speed and bandwidth to be given specified requirements. The Holos modelling assesses the impact of those variables in relation to customer behaviour and expectations. The platform model, B, allows variables such as buffer size, application mapping, scheduler features and priorities to be modelled. The applications model, C, allows application mapping, non-functional specifications and logical connectivity to be considered. The system infrastructure model, D, allows business process mapping and service level agreement variables to be explored. The relationship of all these of models with each other and also with the customer behaviour and expectations mentioned above, together with business behaviour and expectations is permitted by the Holos system 10 described herein.

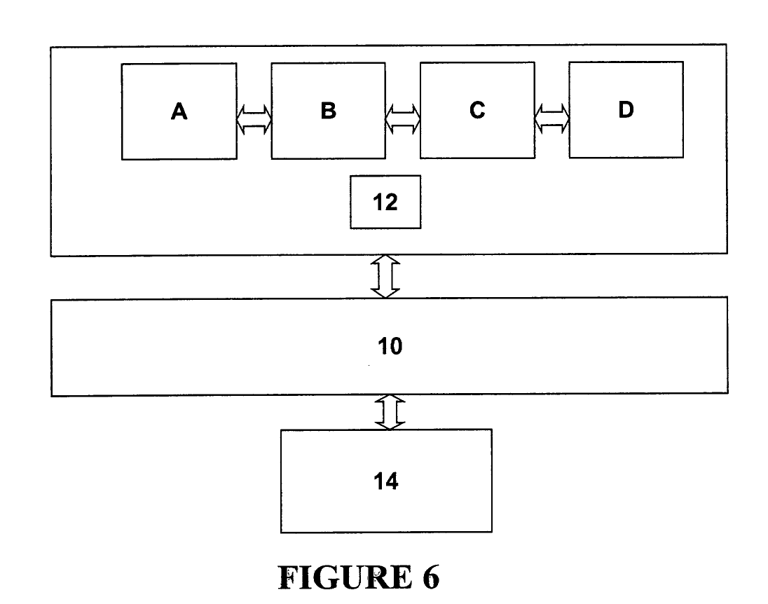

An example of an implementation of the Holos system 10 is shown in FIG. 6. The Process Manager software product of Hewlett-Packard (see www.hp.com for more details) is used to represent, document and model business processes A, B, C and D in box 12. Webquos 14 (see www.hp.com for more details), also a product of Hewlett-Packard, provides control mechanisms for features such as queues and priorities which allows the imposition of service level objectives on a website.

Holos 10 is used to unite the Process Manager section 12 and Webquos section 14 together. Service level agreements expressed in Process Manager can be translated with Holos into objectives, which themselves can be translated into Webquos policies and controls.

Many types of model can be used in Holos to express a particular situation. Types of modelling include specific, numerical, deterministic, continuous, qualitative, fitted, general, analytical, stochastic, discrete, quantitive and exploratory.

### REFERENCES

[1] (A. Ames, D. Nadeau & J. Moreland, VRML 2.0 Sourcebook (2_{nd} Edition) John Wiley & Sons, 1996);

[2] (G. Birtwistle. DEMOS—a system for discrete event modelling on Simula. Macmillan, London, 1979);

[3] (G. Birtwistle, O-J. Dahl, B. Myhrhaug, and K. Nygarrd. Simula begin. Studentlitteratur, Lund, Sweden, 1973);

[4] (G. Birtwistle, R. Pooley, and C. Tofts. Characterising the Structure of Simulation Models in CCS. Transactions of the Society for Computer Simulation, 10(03):205-236, 1993).

[5] (G. Birtwistle and C. Tofts. Operational Semantics of Process-Oriented Simulation Languages. Part 1:πDEMOS. Transactions of the Society for Computer Simulation, 10(4):299-333, 1993);

[6] (G. Birtwistle and C. Tofts. Operational Semantics of Process-Oriented Simulation Languages. Part 2: μDEMOS. Transactions of the Society for Computer Simulation, 11(4):303-336, 1994);

[7] (G. Birtwistle and C. Tofts. Relating Operational and Denotational Descriptions of πDEMOS. Simulation Practice and Theory, 5(1):1-33,1997];.

[8] (G. Birtwistle and C. Tofts. Getting DEMO Models Right-Part I: Practice. to appear Transactions of the Society for Computer Simulation, 2001;

[9] (G. Birtwistle and C. Tofts. Getting DEMOS Models Right—Part II; . . . and Theory, to appear Transactions of the Society for Computer Simulation, 2001);

[10] (B. Steffen. The Concurrency Workbench: A Semantics-Based Tool for the Verification of Concurrent Systems. ACM Transactions on Programming Languages and Systems, 15(1), 1993);

[11] (R. Milner. Calculi for Synchrony and Asynchrony. Theoretical Computer Science, 25:267-310, 1983);

[12] (R. Milner. Communication and Concurrency. Prentice-Hall, London, 1989);

[13] (R. Milner, M, Tofte, D. MacQueen & R. Harper. Definition of Standard ML. The MIT press, 1997);

[14] (R. Milner, Communication and Mobile Systems. CUP, 1999).

[15] (F. G. Moller. The Edinburgh Concurrency Workbench, Version 6.0. Technical Report, Computer Science Department, University of Edinburgh, 1991, R. Cleveland, J. Parrow);

[16] (L. C. Paulson ML for the Working Programmer, Cambridge University Press, 1996).

[17] (W. Reisig. A primer in Petri Net Design, Springer Compass International, 1992);

[18] (W. Reisig. Elements of Distributed Algorithms: Modelling and Analysis with Petri Nets, Springer Verlag, 1998);

[19] (W. Reisig & G. Rozenburg (Eds), Lectures on Petri Nets Basic Models; Advances in Petri Nets, Springer Verlag Lecture Notes in Computer Science, 1491, 1998);

[20] (R. Sahner, K. S. Trivedi & A. Puliafito. Performance and Reliability Analysis of Computer System: An Example-Based Approach Using the Sharpe Software Package, Kluwer Academic Publishers, 1995);

[21] (C. Tofts. Processes with Probability, Priority and Time. Formal Aspects of Computer Science, 6(5):536-564, 1993, C. Tofts. Performance Modelling Using Probabilistic Process Algebra.

[22] (C. Tofts and G. Birtwistle. A denotational semantics for a process-based simulation language);

[23] (C. Tofts. Symbolic Approaches to Probability Distributions in Process Algebra. To appear, Formal Aspects of Computer Science, 2001);

[24] (T. Hoare, M. Broy, R. Steinbruggen, editors, Engineering Theories of Software Construction Vol. 180, pp223-257, 2001);

[25] (C. Tofts. The Operational Semantics of DEMOS2k.

Report HPL-2001-263 Hewlett Packard Research Laboratories Bristol, 2001);

[26] (C. Tofts. Translating DEMOS into Petri Nets.

Report HPL-2001-274 Hewlett Packard Research Laboratories Bristol, 2001).

[27] (L. Wall, T. Christiansen & J. Orwant, Programming Perl (3^{rd} Edition), O'Reilly & Associates, 2000).

[28] (L. C. Paulson. ML for Working Programmer, 28 Jun. 2000, Cambridge University Press.

[29] (E. W. Dijkstra. The Solution of a Problem in Concurrent Programming. CACM, 8(9), 1965.

1. A method of modelling business processes and/or logical networks comprises:
expressing at least two models in a common language wherein each model relates to at least part of a business process and/or a logical network;
executing the at least two models in the common language; and
abstracting the at least two models to simplify said at least two models.

2. A method as claimed in claim 1, which preferably includes providing questions to at least one of the models, with a view to simplifying at least one of the models, based on an answer/answers received from the model.

3. A method as claimed in claim 1, in which the models include variable parameters that are common between at least two models.

4. A method as claimed in claim 1, in which the questions are provided to assess the impact of a variation in behaviour of at least one of the models on another of the models.

5. A method as claimed in claim 1, in which the questions are asked to assess the effect of deleting or refining a section of at least one model.

6. A method as claimed in claim 1, in which a question may be in the form of one or more variable parameters for input into at least one of the models.

7. A method as claimed in claim 1, in which the at least two models represent different aspects of the business process/logical network being modelled.

8. A method as claimed in claim 7, in which the aspects at least partially overlap, or have at least one variable in common.

9. A method as claimed in claim 1, in which a first of the at least two models represents a first modelling domain, a second of the at least two model represents a second modelling domain, and the method includes translation of results and/or requirements of the at least two models between the first and second modelling domains.

10. A method as claimed in claim 1, in which the common denotational language expression of one of the models is translated/compiled into a mathematical notation that is suited to the model concerned or suited to a question to be asked of the model concerned.

11. A method as claimed in claim 10, in which the mathematical notation is one or more of Petri Nets, differential equations, process algebra, or other notational forms.

12. A method as claimed in either claim 10, in which the translation between modelling domains and/or representations of the models allows different aspects of the models to be considered, to thereby assist in simplification of the models.

13. A method as claimed in claim 1, which allows real time running of a business process model and/or logical network simulation.

14. A method as claimed in claim 1, in which the denotational language is DEMOS2K.

15. A method as claimed in claim 1, in which more than two models are described in the common language.

16. A method as claimed in claim 1, in which the models are two or more of a business model, a user model, a system architecture model, an operational model and/or a finance model.

17. A computer programmed to perform the method of of claim 1.

18. A recordable medium bearing the computer program operable to perform the method of claim 1.

19. A method of modelling business processes and/or logical networks comprises:
expressing at least two models of at least part of a business process and/or a logical network in DEMOS2K;
executing the at least two models in DEMOS2K; and
abstracting the at least two models to simplify said at least two models, wherein the method includes providing questions to at least one of the models with a view to simplifying at least one of the models.
